(19) United States
(12) Patent Application Publication
(10) Pub. No.: US 2026/0362217 A1
(43) Pub. Date: Nov. 12, 2026

(54) METHOD FOR PROVIDING IMPORTANT COMMUNICATION SERVICE AND APPARATUS THEREFOR

(71) Applicant: HYUNDAI MOBIS CO., LTD., Seoul (KR)

(72) Inventor: SU HAN CHOI, Gwacheon-si, Gyeonggi-do (KR)

(73) Assignee: HYUNDAI MOBIS CO., LTD., Seoul (KR)

(21) Appl. No.: 19/125,638

(22) PCT Filed: Dec. 7, 2023
(86) PCT No.: PCT/IB2023/062344

§ 371 Date: Apr. 29, 2025

(30) Foreign Application Priority Data
Nov. 7, 2022 (KR) 10-2022-0146936

(51) Int. Cl. H04W 28/02; H04W 76/20; H04W 84/06

(52) U.S. Cl. CPC H04W 28/0268; H04W 28/0273; H04W 76/20; H04W 84/06

(57) ABSTRACT

The present document relates to a method for stably providing an important communication service and an apparatus therefor. To this end, the method by which a user equipment (UE) provides a communication service through a network in a mobile communication system comprises: receiving, from the network, a first message including information for a bearer configuration or reconfiguration; and establishing a bearer with the network on the basis of the information of the first message, wherein the information of the first message includes configuration information for mapping, on the basis of an ID (QFI) assigned to each quality of service (QoS) flow, two or more data radio bearers (DRBs) to a QoS flow corresponding to a specific QFI.

### TECHNICAL FIELD

The following description relates to a method and apparatus for stably providing an important communication service.

### BACKGROUND

Wireless communication systems use various technologies such as LTE, LTE-Advanced, and WiFi, including 5G. The three major requirement areas of 5G are (1) enhanced mobile broadband (eMBB), (2) massive machine type communication (mMTC), and (3) ultra-reliable and low latency communications (URLLC). Some use cases may require multiple areas for optimization, while other use cases may focus on only one key performance indicator (KPI). 5G supports these various use cases in a flexible and reliable manner.

Among them, URLLC includes new services that will change industries through ultra-reliable/available low-latency links, such as remote control of critical infrastructure and self-driving vehicles. The level of reliability and latency is essential for smart grid control, industrial automation, robotics, drone control, and coordination.

The URLLC technology described above may be seen as a way to provide an important communication service with ultra-reliability and low latency. Even in this case, however, a link may be disconnected due to a poor channel condition or for various reasons, and in particular, there are limitations in stably providing an important service in a high-speed, aerial situation such as an uncrewed aerial system (UAS) as well as general vehicle communication.

### DISCLOSURE

### Technical Problem

In order to solve the above problem, one aspect of the present disclosure intends to provide a method and apparatus for stably providing an important communication service even in a situation such as a UAS.

Specifically, a method and apparatus for performing communication by mapping two or more data radio bearers (DRBs) to a quality of service (QoS) flow corresponding to a specific QoS flow identifier (QFI), based on a QFI assigned to each QoS flow for important communication are provided.

For example, a method of configuring a bearer for command and control (C2) communication, which is important communication used to control an unscrewed aerial vehicle (UAV) in a UAS, to stably provide the C2 communication, and a signaling method therefor are proposed.

Further, when communication is performed by mapping two or more DRBs to a QoS flow corresponding to a specific QFI, an operation in each layer of a user equipment (UE) and a network is specifically proposed.

Further, when a plurality of bearers are configured for C2 communication, a method of encoding C2 communication data by mapping it to a plurality of bearers in a transmitter is also described.

Further, a method of reconfiguring a bearer for C2 communication at a transmitting side based on feedback information for C2 communication data is also described.

Further, when two or more bearers are configured for a corresponding service, a method of decoding data and a method of processing feedback information in a receiver are also described.

The problems which the present disclosure could solve are not limited to the problems described above, and other problems not described may be clearly understood by those skilled in the art to which the present disclosure belongs from the following description.

### Technical Solution

In an aspect of the present disclosure for solving the above problems, a method of receiving a communication service through a network by a user equipment (UE) in a mobile communication system is proposed, including receiving a first message including information for bearer configuration or reconfiguration from the network, and establishing a bearer with the network based on the information of the first message. The information of the first message includes configuration information for mapping two or more data radio bearers (DRBs) to a quality of service (QoS) flow corresponding to a specific QoS flow identifier (QFI) based on a QFI assigned to each QoS flow.

The mobile communication system may include an uncrewed aerial system (UAS), and the QoS flow corresponding to the specific QFI may include a QoS flow corresponding to a command and control (C2) communication service of the UAS.

The UE may include a service data adaptation protocol (SDAP) entity defined to perform mapping between QoS flows and DRBs, and the SDAP entity may map the two or more DRBs to the QoS flow corresponding to the specific QFI based on the configuration information.

The UE may include a packet data convergence protocol (PDCP) entity performing transfer, header compression, and ciphering of user data, and the PDCP entity may check duplicate transmission and omission through a PDCP sequence number (SN) of a protocol data unit (PDU) transmitted and received by being mapped to the two or more DRBs.

The UE may include a physical layer entity performing decoding on data received by being mapped to the two or more DRBs, and the physical layer entity may decode all of the data received through the two or more DRBs.

The method may further include transmitting a feedback signal to the network according to a result of the decoding, and when decoding of at least one of the data received through the two or more DRBs is successful, the feedback information may include information indicating an acknowledgment response.

The physical layer entity may decode only one of the data received through the two or more DRBs according to an indication received from the network.

The network may manage QoS IDs that define characteristics for specific QoS flows of the network, and the QoS IDs may include a first group for a guaranteed bit rate (GBR) resource type, a second group for a non-GBR resource type, a third group for a delay-critical GBR resource type, and a fourth group for a resource type for a QoS flow to which two or more DRBs are mapped.

The fourth group may be set for a resource type for a QoS flow for which ultra-reliability or duplicity characteristics are considered in addition to the third group.

The first message may be a radio resource control (RRC) reconfiguration message, and the UE may configure a signaling radio bearer (SRB) with the network during an RRC connection establishment process before receiving the RRC reconfiguration message.

When data is transmitted for the C2 communication service, the same data may be mapped to the two or more DRBs and transmitted, respectively.

The network may include a gNB and a core network (CN), and two or more bearers may be established on a radio link between the UE and the gNB, for end-to-end (E2E) QoS control of the C2 communication service.

Two or more bearers may be established on a link between the gNB and the CN, for the E2E QoS control in a specific situation.

The CN may include a session management function (SMF) entity and a user plane function (UPF) entity, and the UPF may receive an external IP packet and map the IP packet to the specific QFI.

The UPF may map the IP packet according to a packet detection rule (PDR) set by the SMF.

The first message may include a non-access-stratum (NAS) message, and a QoS rule for mapping the two or more DRBs to the QoS flow corresponding to the specific QFI may be provided in a PDU session setup or modification procedure.

The UE may include an uncrewed aerial vehicle (UAV).

The mobile communication system may include a mobile communication service provider system and the UAS, and the network may link the mobile communication service provider system to the UAS.

In another aspect of the present disclosure for solving the above problems, a method of providing a communication service to a UE by a network in a mobile communication system is proposed, including transmitting a first message including information for bearer configuration or reconfiguration to the UE, and establishing a bearer with the UE based on the information of the first message. The information of the first message includes configuration information for mapping two or more DRBs to a QoS flow corresponding to a specific QFI based on a QFI assigned to each QoS flow.

The network may include an SDAP entity defined to perform mapping between QoS flows and DRBs, and the SDAP entity may map the two or more DRBs to the QoS flow corresponding to the specific QFI based on the configuration information.

The network may include a PDCP entity performing transfer, header compression, and ciphering of user data, and the PDCP entity may check duplicate transmission and omission through a PDCP SN of a PDU transmitted and received by being mapped to the two or more DRBs.

The network may include a physical layer entity performing decoding on data received by being mapped to the two or more DRBs, and the physical layer entity may decode all of the data received through the two or more DRBs.

On the contrary, the physical layer entity may decode only one of the data received through the two or more DRBs according to an indication received from the network.

In another aspect of the present disclosure for solving the above problems, a UE for receiving a communication service through a network in a mobile communication system is proposed, including at least one processor and at least one computer memory operably connectable to the at least one processor and storing instructions that, when executed, cause the at least one processor to perform operations. The operations include receiving a first message including information for bearer configuration or reconfiguration from the network, and establishing a bearer with the network based on the information of the first message. The information of the first message includes configuration information for mapping two or more DRBs to a QoS flow corresponding to a specific QFI based on a QFI assigned to each QoS flow.

In another aspect of the present disclosure for solving the above problems, a network for transmitting a communication service to a UE in a mobile communication system is proposed, including at least one processor and at least one computer memory operably connectable to the at least one processor and storing instructions that, when executed, cause the at least one processor to perform operations. The operations include transmitting a first message including information for bearer configuration or reconfiguration to the UE, and establishing a bearer with the UE based on the information of the first message. The information of the first message includes configuration information for mapping two or more DRBs to a QoS flow corresponding to a specific QFI based on a QFI assigned to each QoS flow.

### Advantageous Effects

According to the embodiments of the present disclosure as described above, an important communication service may be stably provided even in a situation such as a UAS.

Specifically, as communication is performed by mapping two or more DRBs to a QoS flow corresponding to a specific QoS flow ID (QFI) based on an ID (QFI) assigned to each QoS flow for important communication, ultra-reliability may be secured.

For example, a stable communication service may be provided while minimizing signaling overhead by transmitting using two or more bearers for C2 communication of a UAS.

Further, when communication is performed by mapping two or more DRBs for a QoS flow corresponding to a specific QFI, the efficiency of an operation may be secured by specifically defining an operation of each layer in a UE and a network.

Further, a more efficient communication service may be provided by defining a method of decoding data received through two or more bearers and a method of processing feedback information.

The effects obtainable from the present disclosure are not limited to the effects described above, and other effects not described may be clearly understood by those skilled in the art to which the present disclosure belongs from the description below.

### BRIEF DESCRIPTION OF THE DRAWINGS

FIG. 1 is a diagram illustrating the concept of a UAS.

FIG. 2 is a diagram illustrating the concept of duplexing/multiplexing DRBs for an important communication service according to an embodiment of the present disclosure.

FIG. 3 is a diagram illustrating a method of operating a service flow in each stage in a network according to an embodiment of the present disclosure.

FIG. 4 is a diagram illustrating changes of a QoS ID used in a network according to an embodiment of the present disclosure.

FIG. 5 is a diagram illustrating a method of receiving a communication service by a UE according to an embodiment of the present disclosure.

FIG. 6 is a diagram illustrating an RRC connection establishment procedure.

FIG. 7 is a diagram an RRC reconfiguration procedure.

FIG. 8 is a diagram illustrating a data flow in each layer.

FIG. 9 is a diagram illustrating a service data flow for C2 communication according to an embodiment of the present disclosure.

FIG. 10 is a diagram illustrating a structure for duplexing/multiplexing DRBs for C2 communication according to an embodiment of the present disclosure.

FIG. 11 is a diagram illustrating a method of changing a configuration for bearers according to an embodiment of the present disclosure.

FIGS. 12 and 13 are diagrams illustrating methods of decoding data by a receiver according to embodiments of the present disclosure.

FIG. 14 illustrates wireless devices applicable to the present technology.

### DETAILED DESCRIPTION

With reference to the attached drawings, embodiments of the present disclosure will be described in detail so that those skilled in the art may easily implement the present disclosure. However, the present disclosure may be implemented in various different forms and is not limited to the embodiments described herein. In addition, in order to clearly describe the present disclosure, parts that are not related to the description are omitted in the drawings, and similar parts are given similar reference numerals throughout the specification.

Throughout the specification, when it is said that a part “includes” a certain component, this does not mean that other components are excluded, but that other components may be additionally included, unless otherwise specifically stated.

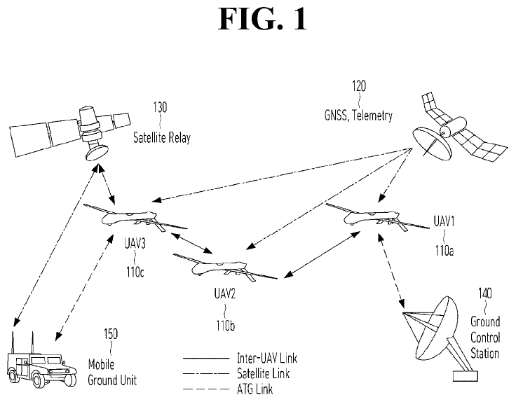

FIG. 1 is a diagram illustrating the concept of a UAS.

As illustrated in FIG. 1, the UAS may include one or more uncrewed aerial vehicles (UAVs) 110a, 110b, and 110c (e.g., drones) and at least one ground control station 140 (or a ground control center or a ground control server) that manages them, and may be linked to a mobile communication service provider system to provide an efficient communication service to the UAV(s).

In the following description, a ‘mobile communication system’ is assumed to be a concept including a mobile communication service provider system operated by a conventional mobile communication service provider, and a UAS. In such a mobile communication system, a conventional mobile communication service and a UAS service may be defined by a single communication standard (e.g., the 3GPP standard).

A network described below may operate to link the mobile communication service provider system to the UAS. That is, in the following description, the network is assumed to be a concept including a network of the mobile communication service provider system and a network for the UAS.

The UAVs 110a, 110b, and 110c may be used as a general concept for unmanned aerial logistics and/or transportation means capable of vertical takeoff and landing, which is only an embodiment. According to another embodiment of the present disclosure, the UAVs 110a, 110b, and 110c may be used as a concept that further includes manned aerial logistics and/or transportation means capable of vertical takeoff and landing.

The mobile communication system may be configured to include a network including a base station (BS) and a core network (CN), and various user devices liked to the network. Hereinafter, various user devices linked to the network will be collectively referred to as “user equipments (UEs)”, for the convenience of description.

In an embodiment, the network may be linked to the ground control station 140 and additionally linked to a global navigation satellite system (GNSS) 120 for providing location information and/or a satellite relay 130 for satellite communication.

In an embodiment, the UE may be provided with a global positioning system (GPS) receiver and directly receive a signal from the GNSS 120 and/or the satellite relay 130.

In another embodiment, the network may be used as a general concept including all of BSs, a CN, and the ground control station 140. In this case, the mobile communication system may be used as a concept including the UAS.

UEs receiving a communication service from the UAS may include not only the UAVs 110a, 110b, and 110c described above, but also a mobile ground unit 150. That is, the ‘UEs’ are assumed to be the UAVs 110a, 110b, and 110c for convenience in the following description, to which the UEs are not limited, and do not exclude the mobile ground unit 150 as illustrated in FIG. 1 or a general mobile phone/smartphone.

In FIG. 1, inter-UAV links may be established among the UAVs 110a, 110b, and 110c and correspond to sidelinks in the 3^{rd} Generation Partnership Project (3GPP). The UAVs 110 a, 110b, and 110c may establish satellite links with the satellite units 120 and 130 and be connected to the ground units 140 and 150 via aerial to ground (ATG) links.

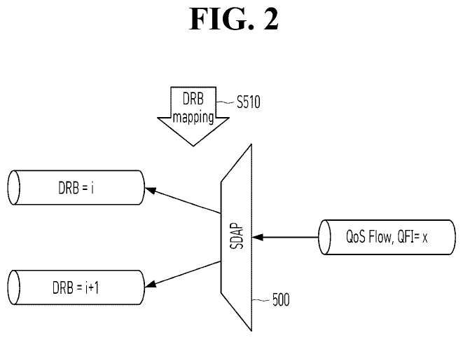

FIG. 2 is a diagram illustrating the concept of duplexing/multiplexing DRBs for an important communication service according to an embodiment of the present disclosure.

In FIG. 2, a transmitter that transmits data may be a UE for uplink transmission, a network for downlink transmission, and a gNB particularly on a radio link. A BS may be referred to as an eNB in LTE and a gNB in 5G, but it may be viewed as a general term for a node communicating with a UE through transmission on a radio link from the perspective of the network. For convenience of description, a BS is referred to as a gNB in the context of 5G, which should not be construed as limiting.

As illustrated in FIG. 2, a transmitting device may manage transmission data on a QoS flow basis, and for this purpose, assign an ID (QoS flow ID (QFI)) to each QoS flow. Accordingly, a specific entity (e.g., service data adaptation protocol (SDAP) 500) of the transmitting device may perform DRB mapping (S510) based on a QFI.

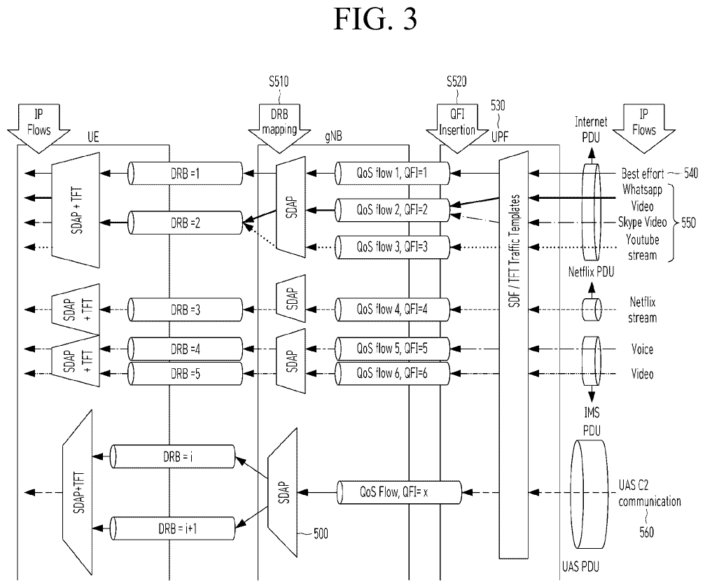

According to the current 5G standardization, there was no case of mapping a QoS flow corresponding to one QFI to two or more DRBs during the DRB mapping (S510) of the SDAP. As described later in relation to FIG. 3, the SDAP functions to map a QoS flow corresponding to one QFI to one DRB or multiplex two or more QoS flows to one DRB in the current 5G standardization.

However, in the present embodiment, a specific QFI (e.g., QFI=x) corresponding to an important communication service such as the C2 communication service of the UAS as described above may be defined, and it is proposed that for a QoS flow having the specific QFI, the corresponding service is provided by mapping the QoS flow to two or more DRBs, as illustrated in FIG. 2. The service with the specific QFI=x mapped to two or more DRBs or a QoS indicator group corresponding to a specific QFI group as described below does not need to be limited to the C2 communication of the UAS as described above. For example, in vehicle-to-everything (V2X) communication, a specific service requiring stability among services currently defined as ultra-reliable low-latency communication (URLLC) may be operated by mapping it to a QFI for which DRB duplication/multiplexing is performed as described above.

FIG. 3 is a diagram illustrating a method of operating a service flow in each stage by a network according to an embodiment of the present disclosure.

As illustrated in FIG. 3, IP flows provided through a communication service may include a best effort service less sensitive to delay, such as a file download service, and a real-time video/audio streaming service sensitive to delay. In addition, the IP flows are shown as including an IP flow for UAS C2 communication in FIG. 3.

A CN that provides the communication service includes an entity of a session management function (SMF) (not shown) and an entity of a user plane function (UPF) 530, and the various IP flows described above may form protocol data units (PDUs) for each service within the CN and provide them to the UPF 530.

The UPF 530 may perform data transmission through a traffic flow template (TFT) in consideration of a service data flow (SDF). Specifically, the UPF 530 may assign/map a QFI to an IP packet received for each SDF (S520).

The UPF 530 may map the IP packet received for each SDF to the corresponding QFI according to a packet detection rule (PDR) set by the SMF (not shown). In the present embodiment, an example is illustrated in which the UPF 530 maps an IP packet for a UAS C2 communication service flow to a specific QFI (=x) (S520).

Thereafter, a gNB of the network may perform DRB mapping corresponding to each QFI (S510), which may be performed by the SDAP 500 of the gNB, for example, for downlink transmission.

According to the current 5G standard as described above, when DRB mapping is performed on a QFI basis in the SDAP 500, only cases where a QoS flow corresponding to one QFI is mapped to one DRB (=1) such as a best effort service 540, or a QoS flow corresponding to a plurality of QFIs is mapped to one DRB (=2) such as various video services 550 have been specified.

However, the present embodiment proposes that for an important communication service such as a UAS C2 communication service 560, a service corresponding to one specific QFI is mapped to two or more DRBs (DRB=i and DRB=i+1) (S510). Preferably, an SDAP of a UE that receives data mapped to a plurality of DRBs in this manner extracts it as one QoS flow data, and it is proposed that the UE performs efficient decoding by considering duplexing/multiplexing. A specific operation of the UE on a receiving side will be described later.

In the present embodiment, the importance of a communication service may be determined based on at least one of delay characteristics required for the service, a guaranteed bit rate (GBR) required for the service, security characteristics (or level) required for the service, whether it is related to the safety of operation (or driving), a data transmission error rate required for the service, or the reliability of link maintenance required for the service, to which the present disclosure is not limited, and the determination may be made by additionally considering various service characteristics according to the design of those skilled in the art.

Although the example of FIG. 3 has been described in the context of downlink data transmission, the concept of DRB duplexing/multiplexing described above may also be substantially applied in the same manner to uplink data transmission.

Specifically, in the case of uplink data transmission, the QFI mapping (S520) and the DRB mapping (S510) may be performed in the UE, and the UE may receive a QoS-related rule through a non-access-stratum (NAS) message received from the network. Specifically, in a PDU session setup or modification procedure, the UE may be provided with a QoS rule (or QoS policy) for mapping two or more DRBs to a QoS flow corresponding to a specific QFI.

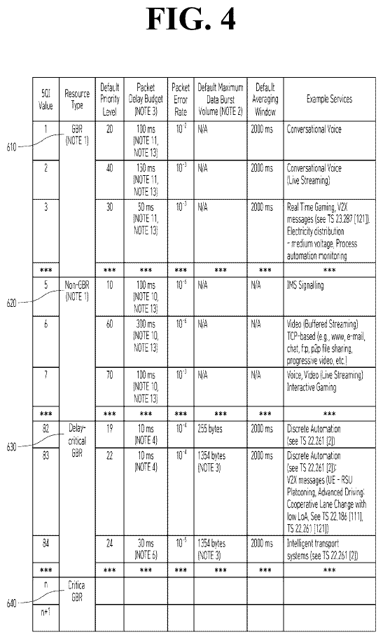

FIG. 4 is a diagram illustrating changes of a QoS ID used in a network according to an embodiment of the present disclosure.

The table illustrated in FIG. 4 is a diagram for describing the concept of groups which are added according to the present embodiment, based on the concept of a 5G QoS identifier (5QIs. However, the term 5QI is a concept used in 5G standardization, and does not need to be construed as limiting. For example, when 5GIs are managed in groups for standardized management on a QoS flow basis in a 6G network, they may be referred to as 6QIs.

For current 5QIs, a first group 610 for a GBR resource type, a second group 620 for a non-GBR resource type, and a third group 630 for a delay-critical GBR resource type are defined, and QoS flows are managed/operated through the groups. However, the present embodiment proposes that a fourth group 640 for a resource type for a QoS flow to which two or more DRBs are mapped as described above is additionally included and operated.

Preferably, the fourth group 640 is set for a resource type for a QoS flow for which ultra-reliability or duplicity characteristics are considered additionally, compared to the third group 630.

Although the QoS ID groups as illustrated in FIG. 4 may be used by the UPF 530 of FIG. 3, they may also be used by various entities within an E2E link as well as the UPF 530.

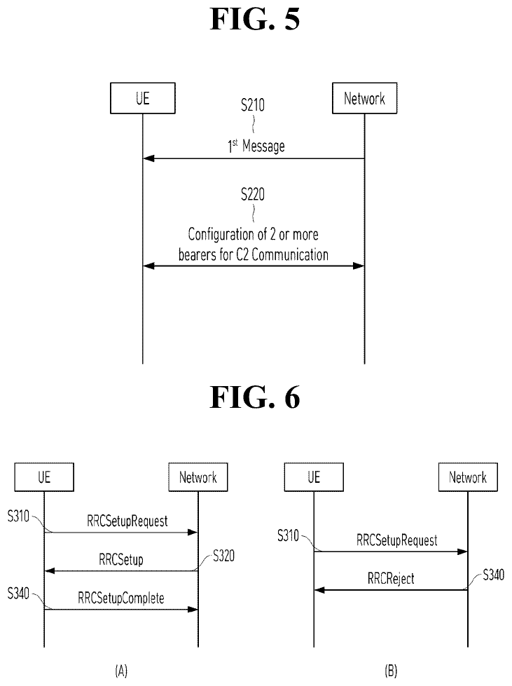

FIG. 5 is a diagram illustrating a method of receiving a communication service by a UE according to an embodiment of the present disclosure.

In 3GPP mobile communication to date, one bearer is configured and used for one specific service in a process of transmitting service data to one UE. However, the present embodiment proposes a method of configuring and using two or more bearers for one service for an important communication service such as a C2 communication service for coordinating UAVs in a UAS.

Configuring a radio bearer (RB) means a process of defining the characteristics of radio protocol layers and channels and setting each specific parameter and operation method in order to provide a specific service. RBs may be divided into two types, signaling radio bearer (SRB) and data radio bearer (DRB). The SRB is used as a path for transmitting an RRC message in the control plane, and the DRB is used as a path for transmitting user data in the user plane.

To this end, it is proposed that in a mobile communication system including a UAS (or linked to the UAS via a network), two or more bearers such as DRBs are configured for a C2 communication service flow of a UAS, when a UE receives a first message including bearer-related information, that is, information for bearer configuration or reconfiguration from a network (S210) and configures bearers with the network based on the first message (S220). Preferably, the information of the first message includes information for configuring two or more bearers for one service flow for C2 communication of the UAS.

The first message may be a radio resource control (RRC) reconfiguration message.

The RRC layer is defined only in the control plane. The RRC layer is responsible for controlling logical channels, transport channels, and physical channels in relation to the configuration, re-configuration, and release of RBs. An RB refers to a logical path provided by the first layer (physical layer or PHY layer), the second layer (medium access control (MAC) layer), the radio link control (RLC) layer, the packet data convergence protocol (PDCP) layer, and the service data adaptation protocol (SDAP) layer, for data transmission between the UE and the network.

When an RRC connection is established between the RRC layer of the UE and the RRC layer of a gNB, the UE is in the RRC_CONNECTED state, and otherwise, it is in the RRC IDLE state. In NR, the RRC_INACTIVE state is additionally defined, and a UE in the RRC INACTIVE state may maintain a connection, for example, a session with a CN, while releasing a connection, for example, a radio link with the gNB. This allows the UE to receive a fast communication service by establishing a radio link as needed without performing a separate session setup procedure in the RRC_INACTIVE state.

FIG. 6 is a diagram illustrating an RRC connection establishment procedure.

The procedure illustrated in FIG. 6 is for establishing an RRC connection. Specifically, (A) of FIG. 6 illustrates a process in which a network responds to transmission of an RRC setup request message from a UE (S310) by transmitting an RRC setup message (S320), and RRC setup completion is performed based on the response (S330), and (B) of FIG. 6 illustrates a case in which the network responds to the transmission of the RRC setup request message from the UE (S310) by transmitting an RRC reject message (S340), resulting in failure of the RRC connection establishment.

The RRC connection establishment of FIG. 6 may be viewed as a procedure of establishing an SRB, particularly SRB1 of the 3GPP.

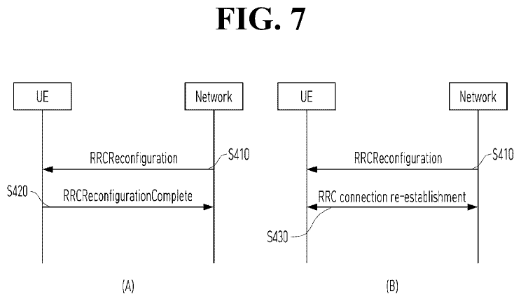

FIG. 7 is a diagram illustrating an RRC reconfiguration procedure.

The RRC reconfiguration procedure illustrated in FIG. 7 is a process for changing an RRC connection, and may be used to perform processes such as configuration/modification/release of an RB/BH RLC channel, reconfiguration based on synchronization information, configuration/modification/release related to measurement, addition/modification/release of an SCell and a cell group, addition/modification/release of a handover configuration, and PSCell modification or addition.

(A) of FIG. 7 illustrates a procedure in which a UE receives an RRC reconfiguration message from a network (S410) and responds with an RRC reconfiguration complete message (S420), thereby succeeding in RRC reconfiguration, and (B) of FIG. 7 illustrates a procedure in which the UE receives the RRC reconfiguration message from the network (S410) and transmits an RRC connection reestablishment message to the network (S430) because it may not perform RRC reconfiguration based on the message.

In the present embodiment, the RRC reconfiguration procedure illustrated in FIG. 7 is proposed as a process of configuring DRBs, for two or more bearers configured to provide a C2 communication service, after establishing an SRB through the RRC connection establishment illustrated in FIG. 6. Data of the C2 communication service for the UAS may be classified as user data within the mobile communication system, that is, the network and provided by being mapped to a DRB. Specifically, the network may transmit DRB information for the C2 communication service to the UE by including it in drb-ToAddModList of a RadioBearerConfig IE of the RRC reconfiguration message.

The description of FIG. 5 and so on has been given on the assumption that the first message (S210) is an RRC message, to which the present disclosure is not limited, and the first message (S210) may be system information or a NAS message.

That is, in the PDU session setup or modification procedure, the UE may be provided with a QoS rule for mapping two or more DRBs to a QoS flow corresponding to a specific QFI through the NAS message (S210) received by the UE, and accordingly, the network may provide the C2 communication service through the two or more DRBs.

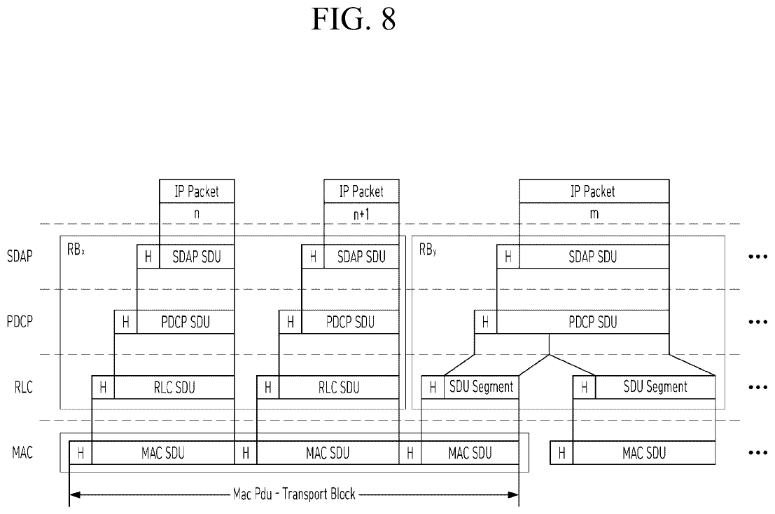

FIG. 8 is a diagram illustrating a data flow in each layer.

Data for a specific service may be mapped to a DRB in the form of an IP packet and transmitted, and the example of FIG. 8 illustrates a process in which IP packets n, n+1, and m are processed on a layer basis.

The SDAP layer is defined only in the user plane. The SDAP layer performs mapping between a QoS flow and a DRB and QoS flow ID marking in downlink and uplink packets. In the example of FIG. 8, IP packets n and n+1 are mapped to RBₓ, and IP packet m is mapped to RB_{y}.

The PDCP layer performs transfer, header compression, and ciphering of user data in the user plane. The functions of the PDCP layer in the control plane include transfer and ciphering/integrity protection of control plane data. In the example illustrated in FIG. 8, the PDCP layer performs header compression and ciphering on a PDCP SDU received from the SDAP layer as described above, and then adds a header to the PDCP SDU and transmit the PDCP SDU to the RLC layer.

The RLC layer performs segmentation and reassembly on an RLC service data unit (SDU). Specifically, in the example illustrated in FIG. 8, the RLC layer divides a PDCP PDU corresponding to IP packet m into two RLC segments. In order to guarantee various quality of service (QoS) requirements for an RB, the RLC layer provides three operation modes, transparent mode (TM), unacknowledged mode (UM), and acknowledged mode (AM). The AM RLC provides error correction through automatic repeat request (ARQ).

The MAC layer provides a service to the RLC layer being a higher layer through a logical channel. The MAC layer provides a function of mapping a plurality of logical channels to a plurality of transport channels. In addition, the MAC layer provides a logical channel multiplexing function by mapping a plurality of a logical channels to a single transport channel. In the example of FIG. 8, the MAC layer multiplexes three MAC SDUs into one MAC PDU. Herein, the multiplexing is performed on a MAC SDU of RB_{y} as well as the MAC SDUs of RBₓ. The MAC sublayer provides a data transfer service on a logical channel.

In the above description, a MAC PDU may be viewed as corresponding to a transport block (TB) in the physical layer. One TB may generally be used as one retransmission unit.

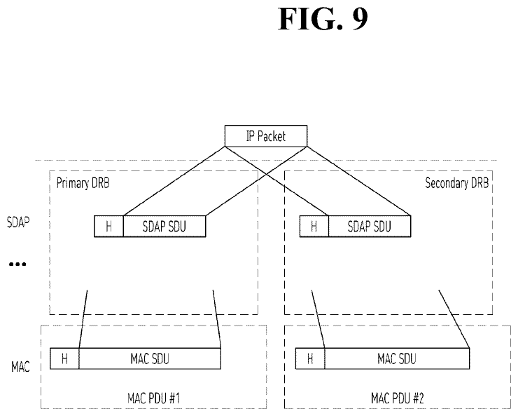

FIG. 9 is a diagram illustrating a service data flow for C2 communication according to an embodiment of the present disclosure.

As illustrated in FIG. 9, the present embodiment proposes that one data (e.g., IP packet) for the C2 communication service is repeatedly transmitted through two or more DRBs. As illustrated in FIG. 9, when two DRBs are used, one DRB may be set as a primary DRB and the other DRB may be set as a secondary DRB. The SDAP may perform DRB mapping such that an IP packet being service data for C2 communication may be repeatedly transmitted through the primary DRB and the secondary DRB.

The size of user data used for C2 communication is relatively small, compared to user data used for a general mobile communication service, such as a video call, file download, video/audio streaming, and web access. For example, data used in the C2 communication service may include sensing data for real-time monitoring of a UAV operation state, various command data for remotely controlling and/or adjusting a UAV, and operation support data related to a congestion state of a vertiport and a corridor. Therefore, in the case of C2 communication, even if the same IP packet is mapped to two DRBs and repeatedly transmitted as illustrated in FIG. 9, resource use and complexity are not significantly increased.

When the same data is mapped to two or more DRBs and repeatedly transmitted as described above, the PDCP layer may perform a management function to avoid data duplication and omission between data through a PDCP sequence number (SN).

In addition, an embodiment of the present disclosure proposes that one MAC PDU used for transmitting a corresponding IP packet does not include data of two or more DRBs. That is, unlike the example of FIG. 8 in which one MAC PDU may transmit SDUs from two RBs by multiplexing them, it is preferable to configure one MAC PDU to include only an SDU from one DRB in an embodiment of the present disclosure as illustrated in FIG. 9. That is, in C2 communication, DRBs and MAC PDUs may be configured to be mapped in a one-to-one correspondence. This is because when two or more RBs are used to secure stability and reliability for an important service such as the C2 communication service, if data mapped to these two or more RBs are transmitted in one MAC PDU TB, the intended service stability and reliability are not secured.

When the method of transmitting the same data through two DRBs is used as illustrated in FIG. 9, one DRB may be transmitted using a frequency resource with a good channel condition, and the other DRB may be transmitted by applying frequency hopping. In general, frequency hopping is a technique of performing communication by changing a main frequency (or carrier frequency) used for data communication in a transmitter/receiver in a wireless network according to a certain function. Since frequency hopping is a technique of performing communication by continuously changing a frequency, it has the advantage of not only stably maintaining a communication link even when external interference occurs at a specific frequency, but also effectively preventing wiretapping and hacking.

In the case of UAVs, there is a possibility that a link that wirelessly controls or adjusts a UAV may be disconnected or maliciously manipulated by a coordinator with bad intentions. Therefore, maintaining a secondary link, that is, a DRB may be very important to cope with such a case. In this case, it may be efficient to apply frequency hopping to only one link, that is, DRB or to apply different frequency hoppings to both links. For example, when frequency hopping is applied to both DRBs, frequency hopping patterns applied to the DRBs may be different from each other. However, this is only an embodiment, and in another embodiment, the frequency hopping patterns applied to the two DRBs may be the same.

In another embodiment of the present disclosure, although two or more bearers may be configured for one C2 communication in the same manner, data may be transmitted only through the primary bearer, and only the secondary bearer may play an auxiliary role such as receiving a feedback signal for the data, unlike the example of FIG. 9.

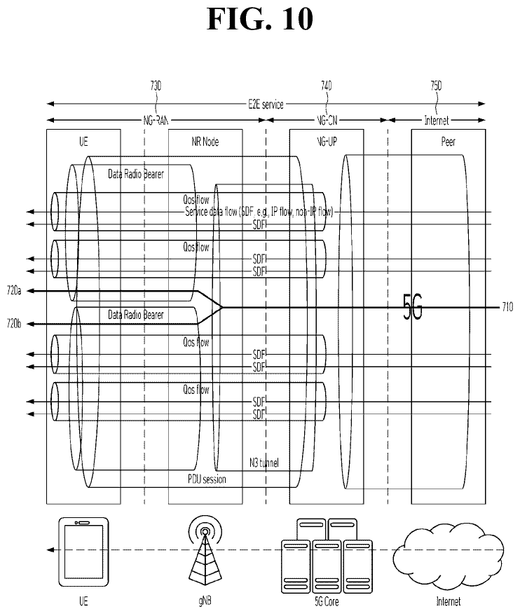

FIG. 10 is a diagram illustrating a structure for duplexing/multiplexing DRBs for C2 communication according to an embodiment of the present disclosure.

In FIG. 10, one arrow indicates a service data flow (SDF), which may include an IP flow and a non-IP flow. Specifically, one SDF may be divided into an Internet link 750, a CN link 740, and a radio link 730.

From the perspective of flows, a network may be viewed as a concept including a gNB and a CN. In addition, an SDF that passes through a UE, the gNB, and the CN may be referred to as an end-to-end (E2E) QoS control flow.

As illustrated in FIG. 9, in duplexing or multiplexing of DRBs, an embodiment of the present disclosure focuses on the radio link 730 between the UE and the gNB rather than the CN link 740, and proposes to duplex/multiplex the DRBs in the radio link 730. This is because the CN link 740 is more stable than communication in the radio link 730, the duplexing/multiplexing of DRBs is focused in the radio link 740 without being performing in the CN link 740.

In the example of FIG. 10, although an SDF for C2 communication is configured as one link 710 in the Internet link 750 and the CN link 740, it is mapped to a first DRB 720a and a second DRB 720b in the radio link 730. That is, a single bearer (or single flow or single session) corresponding to the two or more bearers 720a and 720b may be configured in a link between the gNB and the CN on the link.

However, in another embodiment of the present disclosure, in a specific situation where reliability is threatened (e.g., a malicious user is detected) in the link between the gNB and the CN, two or more bearers (links) (or flows or sessions) may be configured in the same manner as the two or more DRBs 720a and 720b of the radio link.

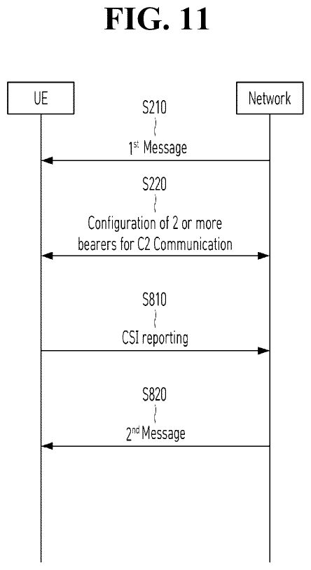

FIG. 11 is a diagram illustrating a method of changing a configuration for bearers according to an embodiment of the present disclosure.

First, an embodiment of the present disclosure proposes that two or more bearers are configured from the beginning during a call setup process. That is, for a specific service such as C2 communication of a UAS, two or more bearers may be configured and used for one service flow during a call setup process.

Specifically, FIG. 11 exemplifies that the first message described in FIG. 5 is received during the call setup process (S210), and the first message may be an RRC reconfiguration message received for the first time after RRC setup. Accordingly, two or more bearers for C2 communication may be configured from the beginning during the call setup process (S220).

In the embodiment of FIG. 11, while the two or more bearers for C2 communication are configured and used during the call setup process, a second message may be received to disable one of the two or more bearers (S820) based on a UE feedback signal (S810) for a channel state such as channel state information (CSI). Whether to receive (transmit) the second message may be determined based on at least one of a channel state, QoS, a radio resource state, or handover. The second message may also have, but is not limited to, the format of the RRC reconfiguration message.

In another embodiment of the present disclosure, in the call setup process, the UE may operate to receive a third message (not shown) including information for configuring one bearer for C2 communication of the UAS from the network, and subsequently receive the first message according to the C2 communication situation of the UAS (S210). The subsequent reception (S210) of the first message may also be determined based on at least one of a channel state, QoS, a radio resource state, or handover, as described above.

A bearer initially configured in the call setup process may be used as a primary bearer, and a bearer added according to information for bearer reconfiguration may be used as at least one secondary bearer.

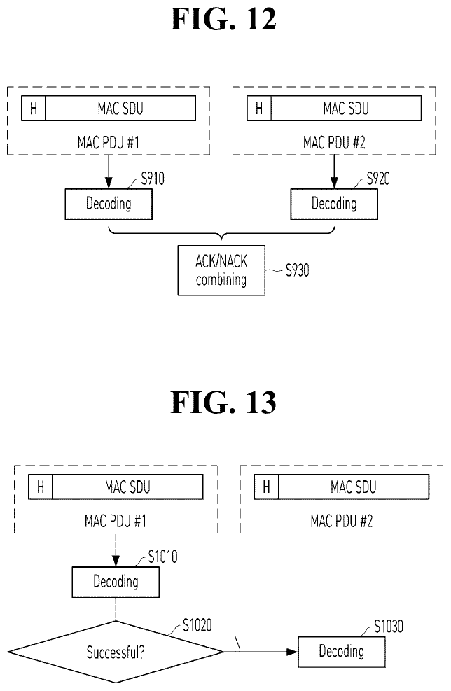

FIGS. 12 and 13 are illustrating methods of decoding data in a receiver according to embodiments of the present disclosure.

Specifically, FIG. 12 is based on the assumption that one IP packet for one C2 communication is mapped to two DRBs and received by a receiver through MAC PDU #1 and MAC PDU #2. In the embodiment illustrated in FIG. 12, it is proposed that the receiver that has received the MAC PDUs performs decoding on both MAC PDUs (S910 and S920).

The receiver needs to transmit a feedback signal (e.g., ACK/NACK) to the transmitter based on a decoding result, and may determine the feedback signal by determining each of the decoding results of the two MAC PDUs MAC PDU #1 and MAC PDU #2 (S930). For example, the receiver may be configured to determine that data for the corresponding C2 communication has been normally obtained and thus transmit an ACK, even if only one of the two MAC PDUs MAC PDU #1 and MAC PDU #2 is successfully decoded, and transmit a NACK only when both the MAC PDUs fail to be decoded.

Compared to the embodiment of FIG. 12, the receiver may be configured to decode only a MAC PDU (MAC PDU #1) received through the primary DRB out of the two MAC PDUs MAC PDU #1 and MAC PDU #2 (S1010) in the embodiment of FIG. 13. When the receiver succeeds in decoding the corresponding MAC PDU (MAC PDU #1), it may feed back an ACK to the transmitter without the need to decode MAC PDU #2.

However, when the receiver fails in decoding MAC PDU #1, it may additionally decode MAC PDU #2 (S1030).

While the method of the embodiment illustrated in FIG. 13 has been illustrated/described on the assumption that the same data is received from two DRBs (primary DRB and secondary DRB), the UE according to the present embodiment may be operated to primarily receive only a MAC PDU through the primary DRB, and receive the subsequent MAC PDU #2 through the secondary DRB according to the failure of decoding of MAC PDU #1. When the transmitter performs a retransmission through a DRB different from a DRB used for an initial transmission, the receiver may have the advantage of obtaining a diversity gain by using the initially received MAC PDU #1 and the retransmitted MAC PDU #2.

In another embodiment, the UE may receive an indication indicating that decoding of one of data transmitted through two or more DRBs is unnecessary from the network. For example, in FIG. 13, upon receipt of MAC PDU #1 and MAC PDU #2, the UE may decode only MAC PDU #1 by the indication received from the network. One DRB is set as a primary DRB and the other DRB as a secondary DRB by RRC signaling, and the indication may indicate that only data of the primary DRB is decoded. In addition, without configuring the primary/secondary DRBs as described above, the network may dynamically signal whether to perform decoding by a MAC CE or an L1/L2 control signal.

While the above embodiment has been described from the perspective of downlink data reception, in the case of uplink data, a physical layer entity of the network may be configured to decode only one of data received through two DRBs. In this case, unlike the downlink case, it is preferable that the network configures decoding of only one data based on its own decision, to which the present disclosure is not limited.

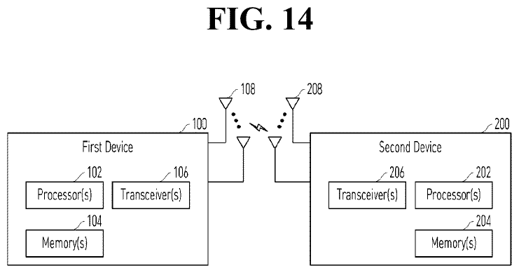

FIG. 14 illustrates wireless devices applicable to the present technology.

Referring to FIG. 14, a first wireless device 100 and a second wireless device 200 may transmit radio signals through a variety of RATs (e.g., LTE and NR). Herein, the first wireless device 100 and the second wireless device 200 may correspond to the UE and the network of FIG. 2, respectively. Specifically, the first wireless device 100 and the second wireless device 200 may be applied to various device located at both ends of a communication link of the UAS illustrated in FIG. 1.

The first wireless device 100 may include at least one processor 102 and at least one memory 104 and further include at least one transceiver 106 and/or at least one antenna 108. The processor 102 may be configured to control the memory 104 and/or the transceiver 106 and implement the description, functions, procedures, proposals, methods, and/or operational flowcharts disclosed in the present disclosure. For example, the processor 102 may process information within the memory 104 to generate first information/signal and then transmit a radio signal including the first information/signal through the transceiver 106. Further, the processor 102 may receive a radio signal including second information/signal through the transceiver 106 and then store information obtained by processing the second information/signal in the memory 104. The memory 104 may be connected to the processor 102 and store various pieces of information related to operations of the processor 102. For example, the memory 104 may store software code including commands for performing some or all of processes controlled by the processor 102 or for performing the description, functions, procedures, proposals, methods, and/or operational flowcharts disclosed in the present disclosure. The processor 102 and the memory 104 may be a part of a communication modem/circuit/chip designed to implement RATs (e.g., LTE E-UTRA or 5G NR). The transceiver 106 may be connected to the processor 102 and transmit and/or receive a radio signal through the at least one antenna 108. The transceiver 106 may include a transmitter and/or a receiver. The transceiver 106 may be interchangeably used with a radio frequency (RF) unit. In the present disclosure, the wireless device may refer to a communication modem/circuit/chip.

The second wireless device 200 may include at least one processor 202 and at least one memory 204 and further include at least one transceiver 206 and/or at least one antenna 208. The processor 202 may be configured to control the memory 204 and/or the transceiver 206 and implement the description, functions, procedures, proposals, methods, and/or operational flowcharts disclosed in the present disclosure. For example, the processor 202 may process information within the memory 104 to generate third information/signal and then transmit a radio signal including the third information/signal through the transceiver 206. Further, the processor 202 may receive a radio signal including fourth information/signal through the transceiver 206 and then store information obtained by processing the fourth information/signal in the memory 204. The memory 204 may be connected to the processor 202 and store various pieces of information related to operations of the processor 202. For example, the memory 204 may store software code including commands for performing some or all of processes controlled by the processor 202 or for performing the description, functions, procedures, proposals, methods, and/or operational flowcharts disclosed in the present disclosure. The processor 202 and the memory 204 may be a part of a communication modem/circuit/chip designed to implement RATs (e.g., LTE E-UTRA or 5G NR). The transceiver 206 may be connected to the processor 202 and transmit and/or receive a radio signal through the at least one antenna 208. The transceiver 206 may include a transmitter and/or a receiver. The transceiver 206 may be interchangeably used with an RF unit. In the present disclosure, the wireless device may refer to a communication modem/circuit/chip.

Hereinafter, hardware elements of the wireless devices 100 and 200 will be described more specifically. One or more protocol layers may be implemented by, but are not limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more protocol data units (PDUs) and/or one or more service data units (SDUs) according to the description, functions, procedures, proposals, methods, and/or operational flowcharts disclosed in the present disclosure. The one or more processors 102 and 202 may generate messages, control information, data, or information according to the description, functions, procedures, proposals, methods, and/or operational flowcharts disclosed in the present disclosure. The one or more processors 102 and 202 may generate signals (e.g., baseband signals) including PDUs, SDUs, messages, control information, data, or information according to the description, functions, procedures, proposals, methods, and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and obtain the PDUs, SDUs, messages, control information, data, or information according to the description, functions, procedures, proposals, methods, and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The description, functions, procedures, proposals, methods, and/or operational flowcharts disclosed in the present disclosure may be implemented using firmware or software and the firmware or software may be configured to include the modules, procedures, or functions. Firmware or software configured to perform the description, functions, procedures, proposals, methods, and/or operational flowcharts disclosed in the present disclosure may be included in the one or more processors 102 and 202 or stored in the one or more memories 104 and 204 so as to be driven by the one or more processors 102 and 202. The description, functions, procedures, proposals, methods, and/or operational flowcharts disclosed in the present disclosure may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured as read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located inside and/or outside of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of the present disclosure, to one or more other devices. The one or more transceivers 106 and 206 may receive user data, control information, and/or radio signals/channels, mentioned in the description, functions, procedures, proposals, methods, and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may control the one or more transceivers 106 and 206 to transmit user data, control information, or radio signals to one or more other devices. The one or more processors 102 and 202 may control the one or more transceivers 106 and 206 to receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the description, functions, procedures, proposals, methods, and/or operational flowcharts disclosed in the present disclosure, through the one or more antennas 108 and 208. In the present disclosure, the one or more antennas may be a plurality of physical antennas or a plurality of logical antennas (e.g., antenna ports). The one or more transceivers 106 and 206 may convert received radio signals/channels from RF band signals into baseband signals in order to process received user data, control information, and radio signals/channels, using the one or more processors 102 and 202. The one or more transceivers 106 and 206 may convert the user data, control information, and radio signals/channels, processed using the one or more processors 102 and 202 from the base band signals into the RF band signals. To this end, the one or more transceivers 106 and 206 may include (analog) oscillators and/or filters.

The detailed description of the preferred embodiments of the present disclosure disclosed above has been provided to enable those skilled in the art to implement and practice the present disclosure. Although the above description has been given with reference to preferred embodiments of the present disclosure, it will be understood by those skilled in the art that various modifications and changes may be made to the present disclosure without departing from the scope of the present disclosure. For example, those skilled in the art may use configurations described in the above-described embodiments in combination.

Accordingly, the present disclosure is not intended to be limited to the embodiments shown herein, but is intended to have the broadest scope consistent with the principles and novel features disclosed herein.

### INDUSTRIAL APPLICABILITY

The method and apparatus for stably providing an important communication service according to the embodiments of the present disclosure as described above may be used in a communication system that supports an important service such as a C2 communication service of a UAS according to various communication protocols as well as the 3GPP.

1. A method of receiving a communication service through a network by a user equipment (UE) in a mobile communication system, the method comprising:
receiving a first message including information for bearer configuration or reconfiguration from the network; and
establishing a bearer with the network based on the information of the first message,
wherein the information of the first message includes configuration information for mapping two or more data radio bearers (DRBs) to a quality of service (QoS) flow corresponding to a specific QoS flow identifier (QFI) based on a QFI assigned to each QoS flow.

2. The method of claim 1, wherein the mobile communication system includes an uncrewed aerial system (UAS), and
wherein the QoS flow corresponding to the specific QFI includes a QoS flow corresponding to a command and control (C2) communication service of the UAS.

3. The method of claim 1, wherein the UE includes a service data adaptation protocol (SDAP) entity defined to perform mapping between QoS flows and DRBs, and
wherein the SDAP entity maps the two or more DRBs to the QoS flow corresponding to the specific QFI based on the configuration information.

4. The method of claim 1, wherein the UE includes a packet data convergence protocol (PDCP) entity performing transfer, header compression, and ciphering of user data, and
wherein the PDCP entity checks duplicate transmission and omission through a PDCP sequence number (SN) of a protocol data unit (PDU) transmitted and received by being mapped to the two or more DRBs.

5. The method of claim 1, wherein the UE includes a physical layer entity performing decoding on data received by being mapped to the two or more DRBs, and
wherein the physical layer entity decodes all of the data received through the two or more DRBs.

6. The method of claim 5, further comprising transmitting a feedback signal to the network according to a result of the decoding,
wherein when decoding of at least one of the data received through the two or more DRBs is successful, the feedback information includes information indicating an acknowledgment response.

7. The method of claim 1, wherein the UE includes a physical layer entity performing decoding on data received by being mapped to the two or more DRBs, and
wherein the physical layer entity decodes only one of the data received through the two or more DRBs according to an indication received from the network.

8. The method of claim 1, wherein the network manages QoS IDs that define characteristics for specific QoS flows of the network, and
wherein the QoS IDs include a first group for a guaranteed bit rate (GBR) resource type, a second group for a non-GBR resource type, a third group for a delay-critical GBR resource type, and a fourth group for a resource type for a QoS flow to which two or more DRBs are mapped.

9. The method of claim 8, wherein the fourth group is set for a resource type for a QoS flow for which ultra-reliability or duplicity characteristics are considered in addition to the third group.

10. The method of claim 1, wherein the first message is a radio resource control (RRC) reconfiguration message, and
wherein the UE configures a signaling radio bearer (SRB) with the network during an RRC connection establishment process before receiving the RRC reconfiguration message.

11. The method of claim 2, wherein data transmitted for the C2 communication service is mapped to the two or more DRBs and equally transmitted repeatedly.

12. The method of claim 2, wherein the network includes a gNB and a core network (CN), and
wherein two or more bearers are established on a radio link between the UE and the gNB, for end-to-end (E2E) QoS control of the C2 communication service.

13. The method of claim 12, wherein two or more bearers are established on a link between the gNB and the CN, for the E2E QoS control in a specific situation.

14. The method of claim 12, wherein the CN includes a session management function (SMF) entity and a user plane function (UPF) entity, and
wherein the UPF receives an external IP packet and maps the IP packet to the specific QFI.

15. The method of claim 14, wherein the UPF maps the IP packet according to a packet detection rule (PDR) set by the SMF.

16. The method of claim 1, wherein the first message includes a non-access-stratum (NAS) message, and
wherein a QoS rule for mapping the two or more DRBs to the QoS flow corresponding to the specific QFI is provided in a PDU session setup or modification procedure.

17. The method of claim 1, wherein the UE includes an uncrewed aerial vehicle (UAV).

18. The method of claim 2, wherein the mobile communication system includes a mobile communication service provider system and the UAS, and
wherein the network links the mobile communication service provider system to the UAS.

19. A method of providing a communication service to a user equipment (UE) by a network in a mobile communication system, the method comprising:
transmitting a first message including information for bearer configuration or reconfiguration to the UE; and
establishing a bearer with the UE based on the information of the first message,
wherein the information of the first message includes configuration information for mapping two or more data radio bearers (DRBs) to a quality of service (QoS) flow corresponding to a specific QoS flow identifier (QFI) based on a QFI assigned to each QoS flow.

20. The method of claim 19, wherein the network includes a service data adaptation protocol (SDAP) entity defined to perform mapping between QoS flows and DRBs, and
wherein the SDAP entity maps the two or more DRBs to the QoS flow corresponding to the specific QFI based on the configuration information.

21. The method of claim 19, wherein the network includes a packet data convergence protocol (PDCP) entity performing transfer, header compression, and ciphering of user data, and
wherein the PDCP entity checks duplicate transmission and omission through a PDCP sequence number (SN) of a protocol data unit (PDU) transmitted and received by being mapped to the two or more DRBs.

22. The method of claim 19, wherein the network includes a physical layer entity performing decoding on data received by being mapped to the two or more DRBs, and
wherein the physical layer entity decodes all of the data received through the two or more DRBs.

23. The method of claim 19, wherein the network includes a physical layer entity performing decoding on data received by being mapped to the two or more DRBs, and
wherein the physical layer entity decodes only one of the data received through the two or more DRBs according to an indication received from the network.

24. A user equipment (UE) for receiving a communication service through a network in a mobile communication system, the UE comprising:
at least one processor; and
at least one computer memory operably connectable to the at least one processor and storing instructions that, when executed, cause the at least one processor to perform operations,
wherein the operations include:
receiving a first message including information for bearer configuration or reconfiguration from the network; and
establishing a bearer with the network based on the information of the first message, and
wherein the information of the first message includes configuration information for mapping two or more data radio bearers (DRBs) to a quality of service (QoS) flow corresponding to a specific QoS flow identifier (QFI) based on a QFI assigned to each QoS flow.

25. A network for transmitting a communication service to a user equipment (UE) in a mobile communication system, the network comprising:
at least one processor; and
at least one computer memory operably connectable to the at least one processor and storing instructions that, when executed, cause the at least one processor to perform operations,
wherein the operations include:
transmitting a first message including information for bearer configuration or reconfiguration to the UE; and
establishing a bearer with the UE based on the information of the first message, and
wherein the information of the first message includes configuration information for mapping two or more data radio bearers (DRBs) to a quality of service (QoS) flow corresponding to a specific QoS flow identifier (QFI) based on a QFI assigned to each QoS flow.
